(19) United States
(12) Patent Application Publication
(10) Pub. No.: US 2008/0126828 A1
(43) Pub. Date: May 29, 2008

(54) DYNAMIC ENABLEMENT AND CUSTOMIZATION OF TRACING INFORMATION IN A DATA PROCESSING SYSTEM

(76) Inventors: Janice Marie Girouard, Austin, TX (US); James K. Lewis, Georgetown, TX (US); Michael Thomas Strosaker, Round Rock, TX (US); Wendel Glenn Voigt, Pflugerville, TX (US)

Correspondence Address: IBM CORP (YA);C/O YEE & ASSOCIATES PC, P.O. BOX 802333, DALLAS, TX, 75380, US

(21) Appl. No.: 11/422,767

(22) Filed: Jun. 7, 2006

(51) Int. Cl. G06F 11/28; G06F 11/07

(52) U.S. Cl. 714/2; 714/45; 714/E11.178; 714/E11.023

(57) ABSTRACT

A computer implemented method, system, and computer usable program code for staged tracing, where an initial high-level trace is performed to detect potential problems or issues at a sub-system level, followed by a dynamic tracing state, with a more detailed level of tracing for an identified problematic sub-system. During such dynamic tracing, the CPU consumption or processing time is monitored and if such consumption remains below a given threshold, additional trace points may be added. If such CPU consumption exceeds the given threshold, existing trace-points are selectively backed-out or removed. The dynamic adding and removing of trace-points allows for the CPU to perform in a desired window of execution performance such that the overall system performance is not adversely affected when tracing is enabled.

### BACKGROUND OF THE INVENTION

1. Field of the Invention

The technical field is generally related to data processing system tools used to analyze and diagnose a data processing system, and in particular is directed to a computer implemented method, system, and computer usable program code for providing improved tracing of software or code that is executing on such data processing system.

2. Description of the Related Art

Finding problems with computer software, also known as debugging software, can be a daunting task. Certain hardware and software tools currently exist to assist a programmer in such debug activities. A software trace facility helps isolate system problems by monitoring selected system events during code execution. Events that can be monitored include: entry and exit to selected subroutines, kernel routines, kernel extension routines, and interrupt handlers. When the trace facility is active, information about these events is recorded in a system trace log file. The trace facility includes commands for activating and controlling traces and generating trace reports. Applications and kernel extensions can use several subroutines to record additional events.

A user would typically invoke tracing by entering a command or invoking some other enabling interaction to enable/disable tracing at specified trace points. For example, a command such as:

trace -a -j 30D, 30E -o tracefile_out

would enable a tracing of code execution for subsystem ids that are numbered 30D and 30E in an AIX® operating system environment (AIX is a trademark of International Business Machines Corporation in the United States and other countries). Other operating environments use similar types of trace commands/operations.

Trace points are not typically enabled on a customer system operating in its normal environment, but rather are generally limited to being used during system debug, due to the adverse effect that tracing can have on system performance. This is because the tracing activity itself consumes system resources such as processor cycles and data storage latencies. The tracing can also adversely effect system operation as the sequencing or timing of data processing operations may be different when tracing is enabled due to such system resource consumption by the tracing operation.

It would therefore be desirable to provide a technique for tracing code or program execution which mitigates the adverse impacts that would otherwise exist when code/program tracing is enabled in a data processing system.

### SUMMARY OF THE INVENTION

A computer implemented method, system, and computer usable program code is provided for staged tracing, where an initial high-level trace is performed to detect potential problems or issues at a sub-system level, followed by a dynamic tracing state, with a more detailed level of tracing for an identified problematic sub-system. During such dynamic tracing, the CPU consumption or processing time is monitored, and if such consumption remains below a given threshold, additional trace points may be added. If such CPU consumption exceeds the given threshold, existing trace-points are selectively backed-out or removed. The dynamic adding and removing of trace-points allows for the CPU to perform in a desired window of execution performance such that the overall system performance is not adversely affected when tracing is enabled.

### BRIEF DESCRIPTION OF THE DRAWINGS

The novel features believed characteristic of the illustrative embodiments are set forth in the appended claims. The illustrative embodiments, however, as well as a preferred mode of use, further objectives and advantages thereof, will best be understood by reference to the following detailed description of an illustrative embodiment when read in conjunction with the accompanying drawings, wherein:

FIG. 1 depicts a network of data processing systems in which illustrative embodiments may be implemented;

FIG. 2 depicts a block diagram of a data processing system in which illustrative embodiments may be implemented;

FIG. 3 depicts an overall state transition diagram for a data processing system operating in accordance with the illustrative embodiments;

FIG. 4 depicts a logical flow diagram of a data processing system having improved trace capabilities which mitigate system overhead associated with debug activities;

FIG. 5 depicts a flowchart for system processing while in the dynamic tracing state;

FIG. 6 depicts a minimal or reduced trace log generated in the error state;

FIGS. 7A-7C depict detailed logs of trace points generated in the dynamic trace state; and

FIG. 8 depicts a detailed log of trace points that includes detailed event/subsystem description information.

### DETAILED DESCRIPTION OF THE PREFERRED EMBODIMENT

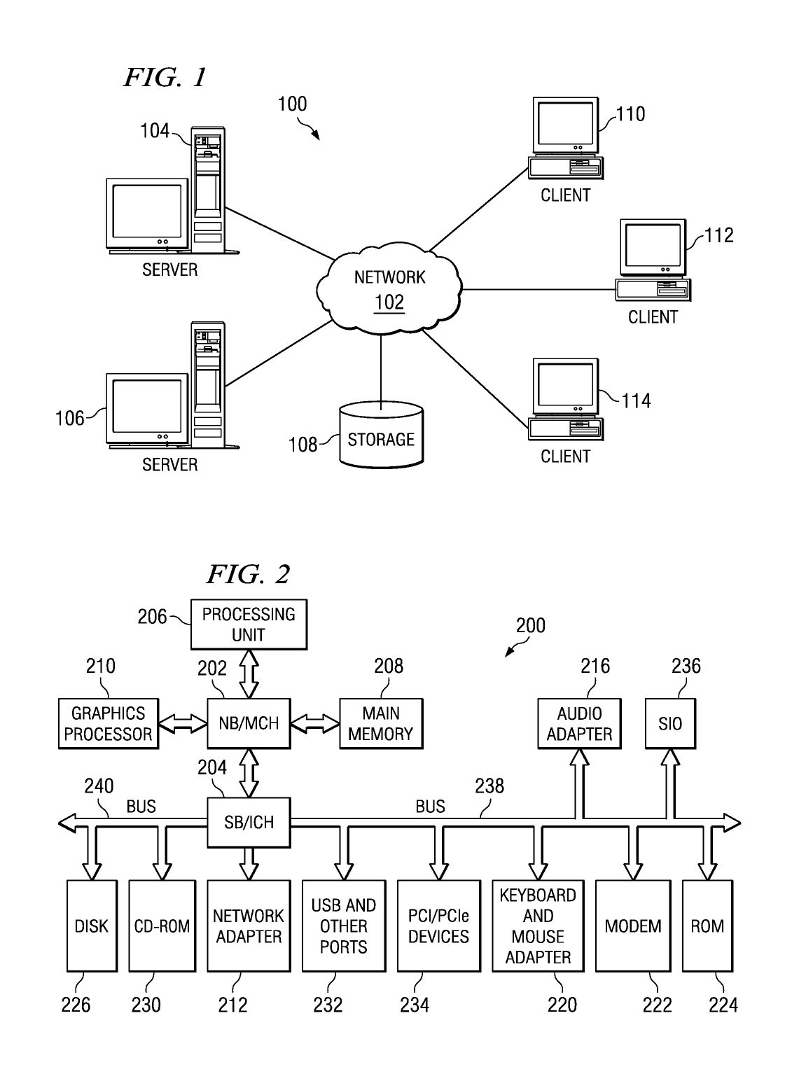

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented many modifications to the depicted environments may be made.

With reference now to the figures, FIG. 1 depicts a pictorial representation of a network of data processing systems in which illustrative embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which illustrative embodiments may be implemented Data processing system 200 is an example of a computer, such as server 104 or client 110 in FIG. 1, in which computer usable code or instructions implementing the processes may be located for the illustrative embodiments.

In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are coupled to north bridge and memory controller hub 202. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processor 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200 (Java and all Java-based trademarks are trademarks of Sun Microsystems, Inc. in the United States, other countries, or both).

Instructions for the operating system, the object-oriented programming system, and applications or programs are located on storage devices, such as hard disk drive 226, and may be loaded into main memory 208 for execution by processor 206. The processes of the illustrative embodiments may be performed by processor 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCd bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

Because subsystem tracing will he described later in this document, an overview of subsystems is in order. When an operating system such as Linux first boots up, the BIOS or a bootloader (lilo, zlilo, grub, etc) loads the Linux kernel from disk to memory, with some parameters defined in the bootloader configuration. The kernel file stays in the /boot directory. The loaded kernel code begins execution in memory and detects a series of vital devices, disk partitions, etc. One of the last things the kernel code does during the initial boot is to mount the filesystem and then calls the program Alit (/sbin/init) and passes the control to init. The init command will read its configuration file (/etc/inittab), which defines the system runlevel and some Shell scripts to be run. These scripts will continue setup of the system's minimal infrastructure, such as activating swap space (virtual memory), mounting other filesystems, etc. Typically, the last step during the kernel boot operation is the execution of a special script called /etc/rc.d/rc, which initializes the subsystems according to a directory structure under /etc/rc.d (the name rc comes from run commands). Major subsystems include process management, memory management, inter-process communication (IPC), and networking. Kernel modules can provide subsystem functionality, such as those listed in Table 1 below.

| | |
|---|---|
| SYS | System Call Entry/Exit |
| TRAP | Trap Entry/Exit |
| IRQ | Interrupt Entry/Exit |
| SCHED | Schedule Change |
| KTIMER | Kernel Timer |
| SIRQ | Soft IRQ Management |
| PROCESS | Process Management |
| FS | File System Management |
| TIMER | Timer Management |
| MEM | Memory Management |
| SOCKET | Socket Communication |
| IPC | IPC Communication |
| NET | Network Device Management |
| NEWEV | Creation of New Event Types |
| CSTM | Custom Event Occurrences |
| HEARTBEAT | Heartbeat Event Occurrences |

In AIX, all of the subsystems can be listed with the following command:

1ssrc -a

A computer implemented method, system, and computer usable program code is provided for staged tracing, where an initial high-level trace is performed to detect potential problems or issues at the sub-system level, followed by a dynamic tracing state, with a more detailed level of tracing for (1) an identified problematic sub-system or (2) sub-levels within a given sub-system (i.e. sub-subsystem level tracing, where particular portions of a given sub-system are traced, such as tracing entry but not exit of a routine, exit but not entry of a routine, reads but not writes to memory, open but not close of a file, etc.). During such dynamic tracing, the CPU consumption or processing time is monitored and if such consumption remains below a given threshold, additional trace points may be added. If such CPPU consumption exceeds the given threshold, existing trace-points are selectively backed-out or removed. The dynamic adding and removing of trace-points allows for the CPU to perform in a desired window of execution performance such that the overall system performance is not adversely affected when tracing is enabled, including detailed tracing at a sub-system or sub-subsystem level.

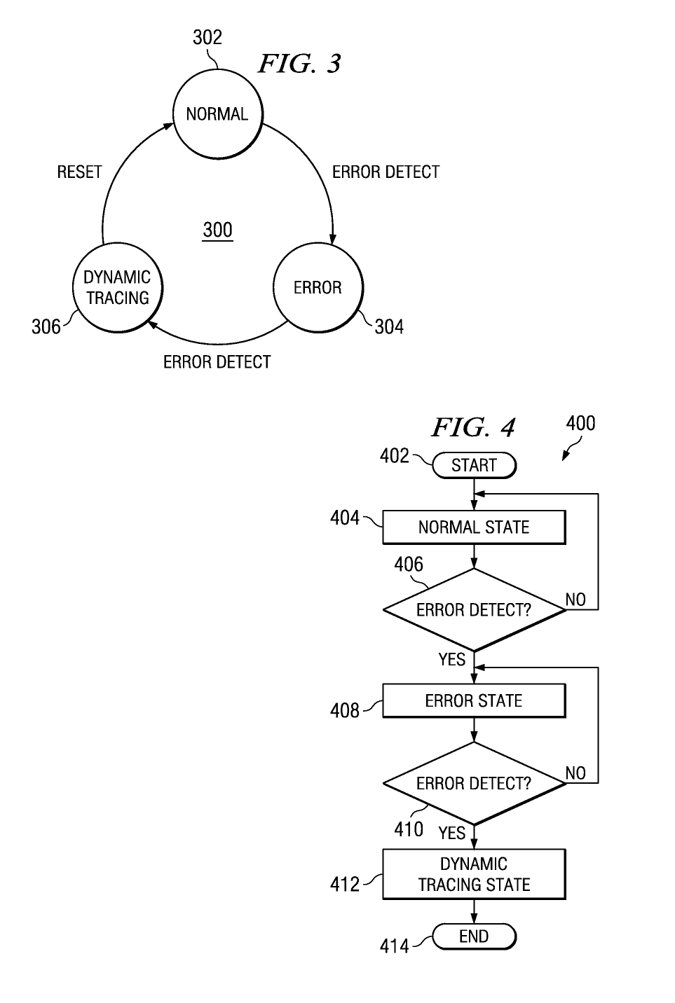

Turning now to FIG. 3, there is shown at 300 an overall state transition diagram for a data processing system operating in accordance with the illustrative embodiments. State 302 is the normal state where the data processing system is executing in its normal fashion in providing processing functionality. upon detection of an error condition, the system goes into an error state shown at 304. In this error state, minimally intrusive logging is initiated, where a trace point is enabled for selected subsystems and when executed, a trace record is written to a log file to identify the subsystem or subsystem identifier (ID). While in error state 304, and upon detection of an additional error, the system goes into dynamic tracing state 306. Because the subsystems were being traced in error state 304, it is possible to determine which subsystem the subsequently detected error is likely associated with, and thus detailed tracing for such subsystem can be enabled while in this dynamic tracing state 306. These operations and state transitions will now be further described.

As previously mentioned, while in normal state 302 the system is operating normally, with no tracing enabled. Once an error is triggered or recognized, such as by the occurrence of an enhanced error handling (EEH) event, ksym oops (kernel error) , or an error monitor daemon (such as a rate daemon that monitors the rate of data errors reported in rx_error or tx_error fields that exist in the Linux net_device_stats structure), the system transitions to an error state. In the error state, tracing is enabled for logging only the appropriate subsystem identifiers (IDs). For example, upon occurrence of a memory event, only the mem subsystem ID would be logged. Previous traditional techniques would log additional information such as source and destination addresses and the length of the buffer copied. Logging only the subsystem ID greatly reduces the amount of processing overhead that would otherwise be associated with tracing/logging code execution. The purpose of the error state is to understand, in general, what was occurring prior to the failure or error condition and to (later) focus detailed tracing for events associated with the particular failed/erroneous subsystem action.

Once in the error state, when another error such as EEH, oops or rate threshold error is detected, the system transitions to the dynamic tracing state. After resuming operations after such detected error, which may require a system re-boot, the system begins to fully enable tracing automatically for the affected subsystem. The trace points are enabled in reverse order. For example, if the last four subsystems traced were IRQ_ENTER, NET, MEM and SOCKET events, respectively, all SOCKET trace points are initially enabled. The consumption is monitored, and if the CPU consumption either remained below an absolute specified level or remained below a relative level considered normal as measured during normal state operation, or enabling the trace points did not cause the trace buffer consumption rates to exceed a predetermined limit, then additional trace points can be added and the next reverse-order subsystem (in the example, MEM) would have its detailed trace points enabled. This process continues until all trace points are enabled or one of the above listed thresholds is reached/exceeded. As trace points for a new subsystem are added, the CPU/trace buffer consumption is monitored. Alternatively, the CPU/trace buffer consumption is timer-driven such that the consumption is periodically monitored. If the predefined limits are met or exceeded, the trace point would be disabled (in the order enabled) while the consumption rate exceeded the defined limits. Trace points are then re-enabled when the consumption rates drop back to acceptable levels. Thus, the trace points are selectively and dynamically enabled and disabled based upon the consumption rate of system resources such as CPU or trace buffer consumption thereby tuning the amount of trace points being enabled to meet the overall performance objectives of the system.

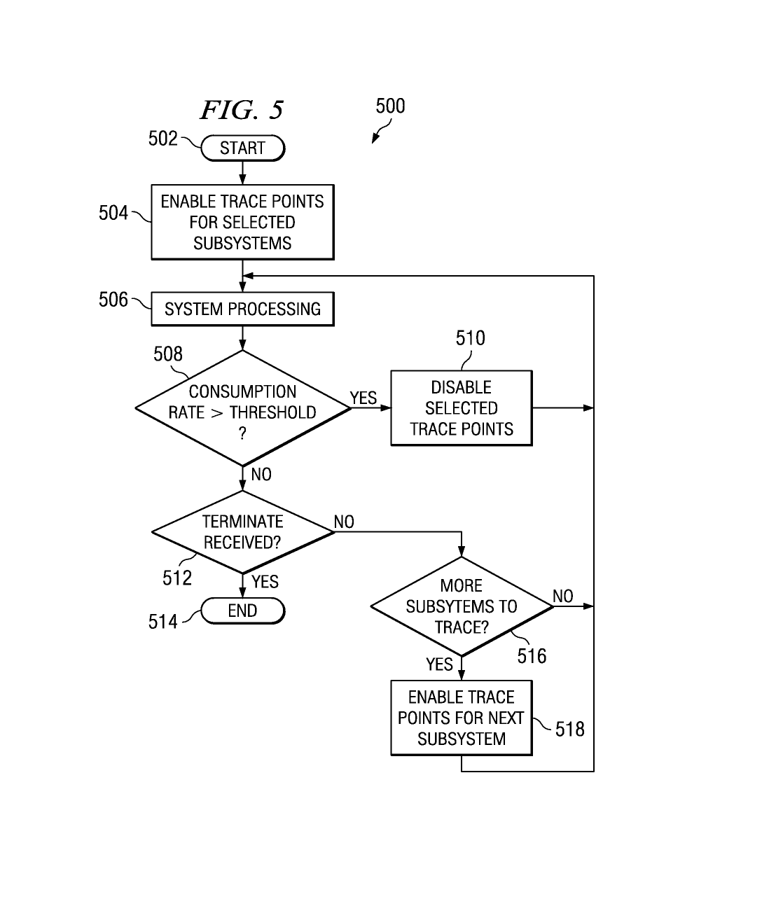

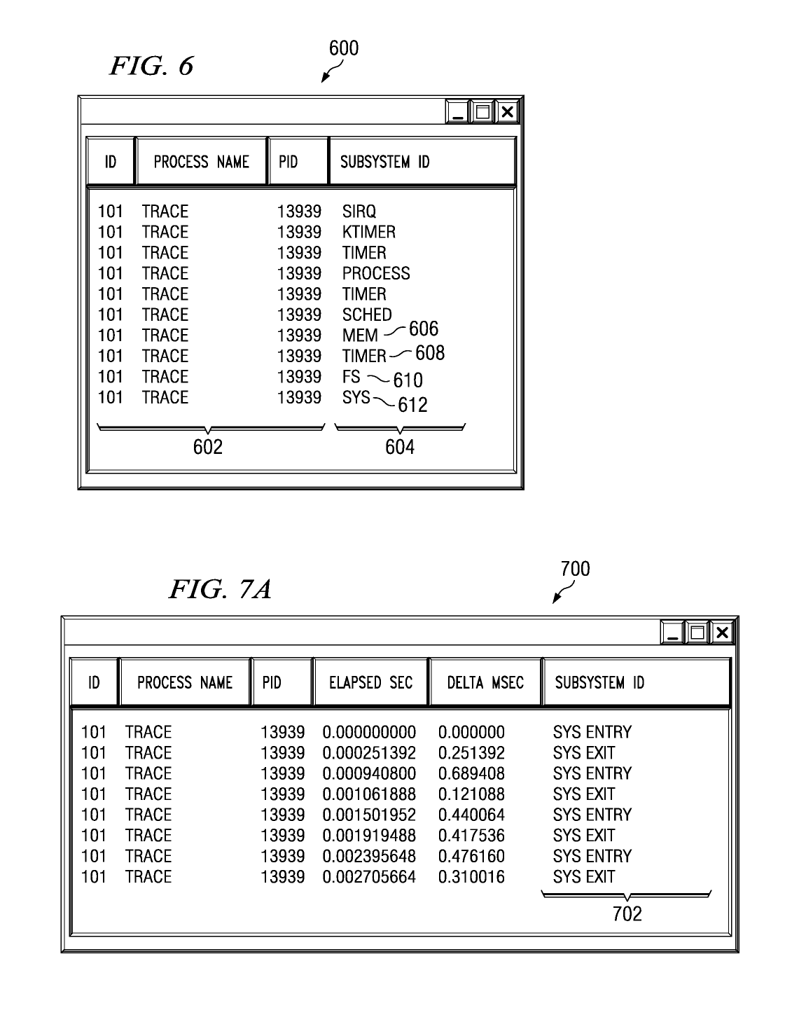

Turning now to FIG. 4, a logical flow diagram of a data processing system having improved trace capabilities which mitigate system overhead associated with debug activities is shown at 400. Processing begins at 402, and proceeds to normal state processing at 404. In such normal state processing, tracing is disabled and the system is operating in its normal intended fashion. If an error condition is detected at 406, such as by detection of an EEH, oops, or rate threshold condition as previously described, the system enters an error state at 408. Otherwise processing continues in the normal state at 404. If in error state 408, a minimally intrusive trace operation is enabled, whereby the subsystem identifiers (subsystem IDs) for each invoked subsystem are logged upon each invocation of such subsystem A representative log is shown in FIG. 6. By only logging the subsystem IDs while in this error state, the affect that the tracing tool has on the overall system processing and associated performance is minimized. while in this error state, if another error is detected at 410, the system transitions to the dynamic tracing state at 412. This dynamic tracing state will be further described with respect to the description below that pertains to FIG. 5. If no error is detected when in the error state, the error state processing with minimal tracing is continued at 408. The dynamic tracing state ends at 414 when an operator ends the debugging session, such as by an operator command or system restart.

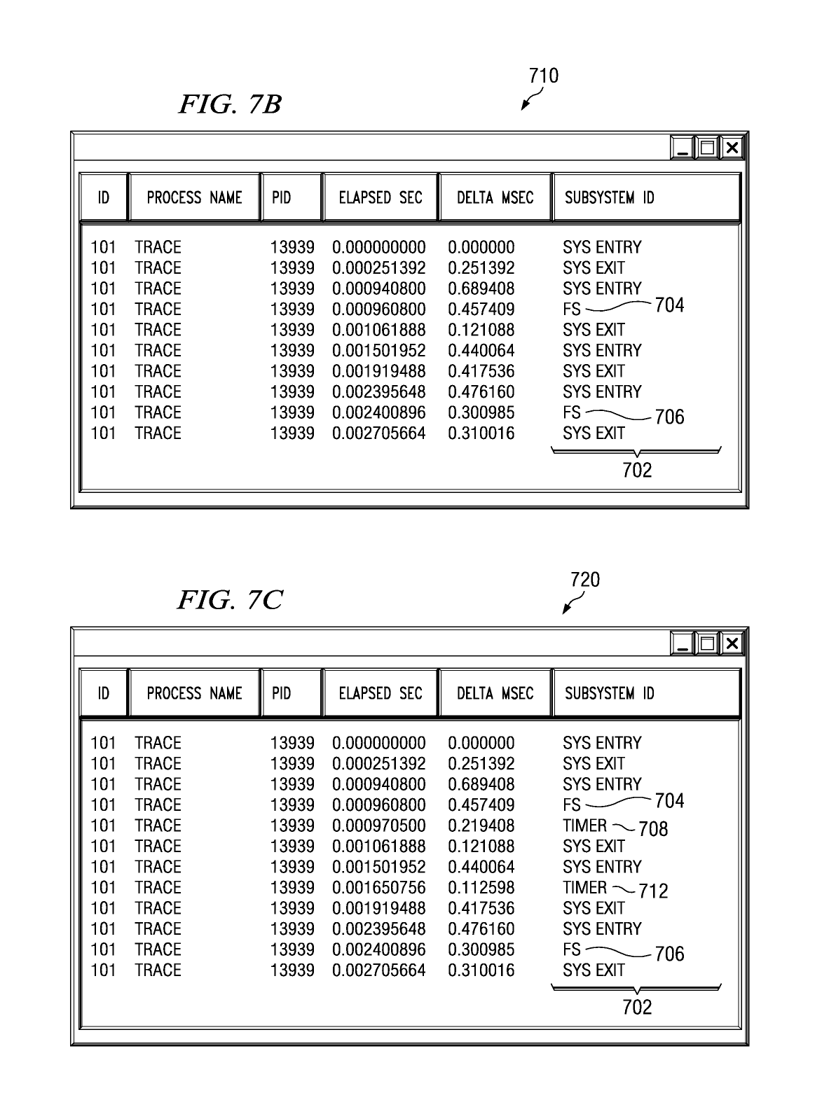

Turning now to FIG. 5, there is shown at 500 a flowchart for system processing while in the dynamic tracing state, such as dynamic tracing state 306 of FIG. 3 or 412 of FIG. 4. Processing starts at 502 and continues to 504 where trace points are enabled for a selected subsystem. This subsystem selection is done in reverse order, where the last subsystem logged in the trace log just prior to the second error condition being detected has its trace points enabled. For example, in looking at a representative portion of log 600 shown in FIG. 6, such log includes an optional process name and identifier field for the trace process itself at 602, and the abbreviated subsystem ID entries 604 that were captured while in an error tracing state. As can be seen at the end of this log, there is shown several log entries for subsystem IDs MEM at 606, TIMER at 608, FS at 610 and SYS at 612. The SYS subsystem as shown at 612 was the last logged entry, and so it would be the first subsystem to have its trace points enabled in the detailed logging stage. A command such as trcstart(“-j SYS”) can be used to invoke such tracing. Similarly, FS subsystem as shown at 610 would be the second subsystem to have its trace points enabled in the detailed logging stage, as it is the next to last entry in log 600. A new command such as trcadd(“-J FS”) can be used to add the FS trace events to the current trace log. Continuing with FIG. 5, the system then continues its normal processing, with selected subsystem trace points enabled to provide a more detailed tracing, at 506. A representative detailed trace log is shown at 700 in FIG. 7A. In the example shown in FIG. 7A, only the SYS subsystem has its trace points enabled, as it was the last log entry in the error state log 600. During such processing, the consumption rate is monitored at 508 to determine if any consumption thresholds have been exceeded. For example, certain system consumption rates are monitored, and (1) if the CPU consumption either (a) exceeds an absolute specified level, (b) exceeds a relative level considered normal as measured during normal state operation, or (2) the trace point enabling causes the trace buffer consumption rates to exceed a predetermined limit, then selected trace points are disabled at 510 in an attempt to mitigate the processing overhead disruption that has been caused by the trace point enablement. A new command such as trcremove(“-J FS”) can be used to disable tracing of FS events. System processing then continues at 506, including consumption rate monitoring at 508. Thus, trace points are selectively disabled at steps 506, 508 and 510 until the system reaches a point of satisfactory operation where consumption rates are not being exceeded. An optional check of whether a debug terminate request has been received is made at 512, and if so, processing ends at 514. Once the consumption rate is within acceptable limits, as determined at 508, it is then possible to dynamically add additional trace points as the system is in a condition to handle additional processing requirements. A check is made at 516 if there are additional subsystems that need to be traced. If so, trace points are enabled for the next subsystem in the reverse order list, and system processing continues at 506, with subsequent consumption rate monitoring at 508 as the addition of these new additional trace points may cause the system to exceed the desired consumption rates. As shown at 710 in FIG. 7B, the FS subsystem has had its trace points enabled, and log entries for such subsystem are shown at 704 and 706. Similarly, as shown at 720 in FIG. 7C, in addition to the SYS and FS subsystems having their trace points enabled, the TIMER subsystem also has its trace points enabled, and log entries for such subsystem are shown at 708 and 712. Thus, trace points for selected subsystems are dynamically enabled and disabled in order to maximize the amount of tracing that is done—in order to log more useful system debug information—while maintaining a desired overall system operating performance. Thus, the tracing tool can be regulated by such dynamic enabling and disabling of trace points such that the trace tool itself does not adversely affect the overall performance of the system under test/debug.

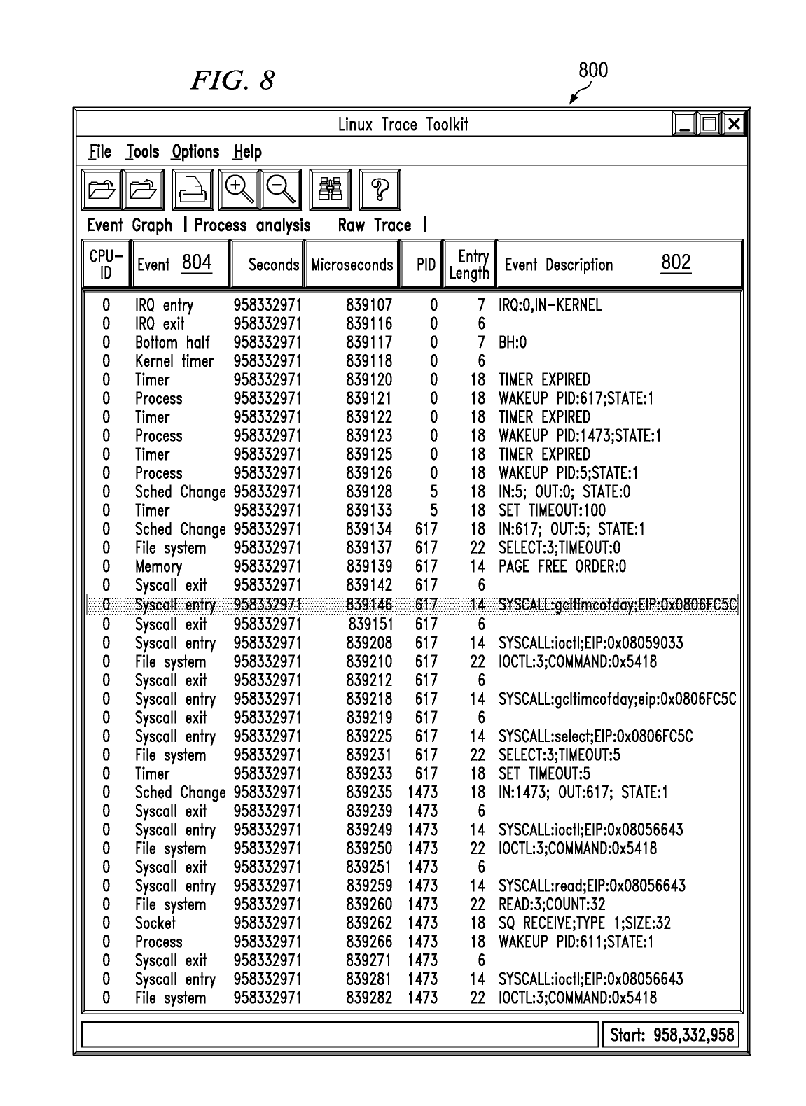

FIGS. 7A-7C do not contain all of the information that occurs in the dynamic tracing state, in order for clarity in depicting the addition of new subsystem trace points that are dynamically enabled when resource consumption so warrants, as described above. A more representative output log, this log being from a Linux environment, is shown at 800 in FIG. 8. Here, detailed Event Description information is listed for each log record at 802. This detailed event description information, which is output to the log when in the dynamic tracing state but is not output when in the error tracing state, provides the additional detailed information pertaining to a particular subsystem trace point that can be used to assist the system operator in assessing the system's operating environment and associated problem(s) that lead to the system entering the dynamic tracing state based on a detected error, as previously described above. It should also be noted that in this Linux environment, what was previously described as subsystems are instead called events, as shown at 804.

The description of a particular trace facility, in particular the trace facility for the AIX operating system, is described in the attached Appendix A, which has been excerpted from a publication entitled AIX Version 4.3 Kernel Extensions and Device Support Programming Concepts, available from IBM Corporation. The described Event IDs are equivalent to the subsystem IDs previously described above.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

### APPENDIX A

Debug and Performance Tracing

The AIX trace facility is useful for observing a running device driver and system. The trace facility captures a sequential flow of time-stamped system events, providing a fine level of detail on system activity. Events are shown in time sequence and in the context of other events. The trace facility is useful in expanding the trace event information to understand who, when, how, and even why the event happened.

Introduction

The operating system is shipped with permanent trace event points. These events provide general visibility to system execution. You can extend the visibility into applications by inserting additional events and providing formatting rules.

Care was taken in the design and implementation of this facility to make the collection of trace data efficient, so that system performance and flow would be minimally altered by activating trace. Because of this, the facility is extremely useful as a performance analysis tool and as a problem determination tool.

The trace facility is more flexible than traditional system monitor services that access and present statistics maintained by the system. With traditional monitor services, data reduction (conversion of system events to statistics) is largely coupled to the system instrumentation. For example, the system can maintain the minimum, maximum, and average elapsed time observed for runs of a task and permit this information to be extracted.

The trace facility does not strongly couple data reduction to instrumentation, but provides a stream of system events. It is not required to presuppose what statistics are needed. The statistics or data reduction are to a large degree separated from the instrumentation.

You can choose to develop the minimum, maximum, and average time for task A from the flow of events. But it is also possible to extract the average time for task A when called by process B, extract the average time for task A when conditions XYZ are met, develop a standard deviation for task A, or even decide that some other task, recognized by a stream of events, is more meaningful to summarize. This flexibility is invaluable for diagnosing performance or functional problems.

The trace facility generates large volumes of data. This data cannot be captured for extended periods of time without overflowing the storage device. This allows two practical ways that the trace facility can be used natively.

First, the trace facility can be triggered in multiple ways to capture small increments of system activity. It is practical to capture seconds to minutes of system activity in this way for post-processing. This is sufficient time to characterize major application transactions or interesting sections of a long task.

Second, the trace facility can be configured to direct the event stream to standard output. This allows a realtime process to connect to the event stream and provide data reduction in real-time, thereby creating a long term monitoring capability. A logical extension for specialized instrumentation is to direct the data stream to an auxiliary device that can either store massive amounts of data or provide dynamic data reduction.

You can start the system trace from:
The command line
SMIT
Software

As shown in the Starting and Stopping Trace Figure below, the trace facility causes predefined events to be written to a trace log. The tracing action is then stopped. Tracing from a command line is discussed in the “Controlling trace” section below. Tracing from a software application is discussed and an example is presented in the “Examples of Coding Events and Formatting Events” section below.

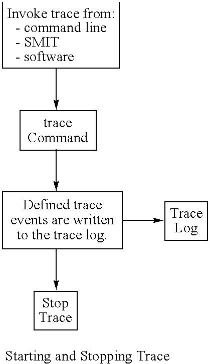

After a trace is started and stopped, you must format it before viewing it. To format the trace events that you have defined, you must provide a stanza that describes how the trace formatter is to interpret the data that has been collected. This is described below in the “Syntax for Stanzas in the trace Format File” section.

The trcrpt command provides a general purpose report facility. The report facility provides little data reduction, but converts the raw binary event stream to a readable ASCII listing of the event stream. Data can be visually extracted by a reader, or tools can be developed to further reduce the data.

For an event to be traced, you must write an event hook (sometimes called a trace hook) into the code that you want to trace. Tracing can be done on either the system channel (channel 0) or on a generic channel (channels 1-7). All preshipped trace points are output to the system channel.

Usually, when you want to show interaction with other system routines, use the system channel. The generic channels are provided so that you can control how much data is written to the trace log. Only your data is written to one of the generic channels.

More information on trace hooks is described below, in the “Macros for Recording trace Events” section.

Using the trace Facility

The following sections describe the use of the trace facility.

Configuring and Starting trace Data Collection

The trace command configures the trace facility and starts data collection. The syntax of this command is:

trace [-a|-f|-1] [-c] [-d] [-h] [-j Event [,Event] ] [-k Event [ ,Event] ] [-m Message ] [-n] [-o OutName] [-o-] [-s ] [-L Size] [-T Size] [-1234567]

The various options of the trace command are:

| | |
|---|---|
| -f or -l | Control the capture of trace data in |
| | system memory. If you specify |
| | neither the -f nor -l option, the |
| | trace facility creates two buffer |
| | areas in system memory to capture |
| | the trace data. These buffers are |
| | alternately written to the log file |
| | (or standard output if specified) as |
| | they become full. The -f or -l flag |
| | provides you with the ability to |
| | prevent data from being written to |
| | the file during data collection. The |
| | options are to collect data only |
| | until the memory buffer becomes full |
| | (-f for first), or to use the memory |
| | buffer as a circular buffer that |
| | captures only the last set of events |
| | that occurred before trace was |
| | terminated (-l). The -f and -l |
| | options are mutually exclusive. With |
| | either the -f or -l option, data is |
| | not transferred from the memory |
| | collection buffers to file until |
| | trace is terminated. |
| -a | Run the trace collection |
| | asynchronously (as a background |
| | task), returning a normal command |
| | line prompt. Without this option, |
| | the trace command runs in a |
| | subcommand mode (similar to the |
| | crash command) and returns a > prompt. |
| | You can issue subcommands |
| | and regular shell commands from the |
| | trace subcommand mode by preceding |
| | the shell commands with an ! |
| | (exclamation point). |
| -c | Saves the previous trace log file |
| | adding .old to its name. Generates |
| | an error if a previous trace log |
| | file does not exists. When using the |
| | -o Name flag, the user-defined trace |
| | log file is renamed. |
| -d | Delay data collection. The trace |
| | facility is only configured. Data |
| | collection is delayed until one of |
| | the collection trigger events |
| | occurs. Various methods for |
| | triggering data collection on and |
| | off are provided. These include the |
| | following: |
| | trace subcommands |
| | trace commands |
| | ioctls to /dev/systrctl |
| -j Event or -k Event | Specifies a set of events to include |
| | (-j) or exclude (-k) from the |
| | collection process. The Event list |
| | items can be separated by commas, or |
| | enclosed in double quotation marks |
| | and separated by commas or blanks. |
| -s | Terminate trace data collection if |
| | the trace log file reaches its |
| | maximum specified size. The default |
| | without this option is to wrap and |
| | overwrite the data in the log file |
| | on a FIFO basis. |
| -h | Do not write a date/sysname/message |
| | header to the trace log file. |
| -m Message | Specify a text string (message) to |
| | be included in the trace log header |
| | record. The message is included in |
| | reports generated by the trcrpt |
| | command. |
| -n | Adds some information to the trace |
| | log header: lock information, |
| | hardware information, and, for each |
| | loader entry, the symbol name, |
| | address, and type. |
| -o Outfile | Specify a file to use as the log |
| | file. If you do not use the -o |
| | option, the default log file is |
| | /usr/adm/ras/trcfile. To direct the |
| | trace data to standard output, code |
| | the -o option as -o-. (When -o- is |
| | specified the -c flag is ignored.) |
| | Use this technique only to pipe the |
| | data stream to another process since |
| | the trace data contains raw binary |
| | events that are not displayable. |
| -1234567 | Duplicate the trace design for |
| | multiple channels. Channel 0 is the |
| | default channel and is always used |
| | for recording system events. The |
| | other channels are generic channels, |
| | and their use is not predefined. |
| | There are various uses of generic |
| | channels in the system. The generic |
| | channels are also available to user |
| | applications. Each created channel |
| | is a separate events data stream. |
| | Events recorded to channel 0 are |
| | mixed with the predefined system |
| | events data stream. The other |
| | channels have no predefined use and |
| | are assigned generically. |
| | A program can request that a generic |
| | channel be opened by using the |
| | trcstart subroutine. A channel |
| | number is returned, similar to the |
| | way a file descriptor is returned |
| | when it opens a file. The program |
| | can record events to this channel |
| | and, thus, have a private data |
| | stream. The trace command allows a |
| | generic channel to be specifically |
| | configured by defining the channel |
| | number with this option. However, |
| | this is not generally the way a |
| | generic channel is started. It is |
| | more likely to be started from a |
| | program using the trcstart |
| | subroutine, which uses the returned |
| | channel ID to record events. |
| -T Size and -L Size | Specify the size of the collection |
| | memory buffers and the maximum size |
| | of the log file in bytes. The trace |
| | facility pins the data collection |
| | buffers, making this amount of |
| | memory unavailable to the rest of |
| | the system. It is important to be |
| | aware of this, because it means that |
| | the trace facility can impact |
| | performance in a memory constrained |
| | environment. If the application |
| | being monitored is not memory |
| | constrained, or if the percentage of |
| | memory consumed by the trace routine |
| | is small compared to what is |
| | available in the system, the impact |
| | of trace “stolen” memory should be |
| | small. |
| | If you do not specify a value, trace |
| | uses a default size. The trace |
| | facility pins a little more than the |
| | specified buffer size. This |
| | additional memory is required for |
| | the trace facility itself. Trace |
| | pins a little more than the amount |
| | specified for first buffer mode (-f |
| | option). Trace pins a little more |
| | than twice the amount specified for |
| | trace configured in alternate buffer |
| | or last (circular) buffer mode. |

You can also start trace from the command line or with a trcstart subroutine call. The trcstart subroutine is in the librts.a library. The syntax of the trcstart subroutine is:

int trcstart(char *args)

where args is simply the options list desired that you would enter using the trace command if starting a system trace (channel 0). If starting a generic trace, include a -g option in the args string. On successful completion, trcstart returns the channel ID. For generic tracing this channel ID can be used to record to the private generic channel.

For an example of the trcstart routine, see the “sample code” section below.

When compiling a program using this subroutine, you must request the link to the librts.a library. Use -l rts as a compile option.

Controlling Trace

Once trace is configured by the trace command or the trcstart subroutine, controls to trace trigger the collection of data on, trigger the collection of data off, and stop the trace facility (stop deconfigures trace and unpins buffers). These basic controls exist as subcommands, commands, subroutines, and ioctl controls to the trace control device, /dev/systrctl . These controls are described in the following sections.

Controlling Trace in Subcommand Mode

If the trace routine is configured without the -a option, it runs in subcommand mode. Instead of the normal shell prompt, → is the prompt. In this mode the following subcommands are recognized:

| | |
|---|---|
| trcon | Triggers collection of trace data on. |
| trcoff | Triggers collection of trace data off. |
| q or quit | Stops collection of trace data (like trcoff) |
| | and terminates trace (deconfigures). |
| !command | Runs the specified shell command. |

The following is an example of a trace session in which the trace subcommands are used. First, the system trace points have been displayed. Second, a trace on the system calls have been selected. Of course, you can trace on more than one trace point. Be aware that trace takes a lot of data. Only the first few lines are shown in the following example:

# trcrpt -j |pg

| | |
|---|---|
| 004 | TRACEID IS ZERO |
| 100 | FLIH |
| 200 | RESUME |
| 102 | SLIH |
| 103 | RETURN FROM SLIH |
| 101 | SYSTEM CALL |
| 104 | RETURN FROM SYSTEM CALL |
| 106 | DISPATCH |
| 10C | DISPATCH IDLE PROCESS |
| 11F | SET ON READY QUEUE |
| 134 | EXEC SYSTEM CALL |
| 139 | FORK SYSTEM CALL |
| 107 | FILENAME TO VNODE (lookuppn) |
| 15B | OPEN SYSTEM CALL |
| 130 | CREAT SYSTEM CALL |
| 19C | WRITE SYSTEM CALL |
| 163 | READ SYSTEM CALL |
| 10A | KERN_PFS |
| 10B | LVM BUF STRUCT FLOW |
| 116 | XMALLOC size, align, heap |
| 117 | XMFREE address, heap |
| 118 | FORKCOPY |
| 11E | ISSIG |
| 169 | SBREAK SYSTEM CALL |

# trace -d -j 101 -m “system calls trace example”
-> trcon
-> !cp /tmp/xbugs .
-> trcoff
-> quit
# trcrpt -o “exec=on,pid=on” > cp.trace
# pg cp.trace
pr 3 11:02:02 1991
System: AIX smiller Node: 3
Machine: 000247903100
Internet Address: 00000000 0.0.0.0
system calls trace example
trace -d -j 101 -m -m system calls trace example

| | | | | | |
|---|---|---|---|---|---|
| ID | PROCESS NAME | PID | I ELAPSED_SEC | DELTA_MSEC | APPL SYSCALL |
| 001 | trace | 13939 | 0.000000000 | 0.000000 | TRACE ON chan 0 |
| 101 | trace | 13939 | 0.000251392 | 0.251392 | kwritev |
| 101 | trace | 13939 | 0.000940800 | 0.689408 | sigprocmask |
| 101 | trace | 13939 | 0.001061888 | 0.121088 | kreadv |
| 101 | trace | 13939 | 0.001501952 | 0.440064 | kreadv |
| 101 | trace | 13939 | 0.001919488 | 0.417536 | kioctl |
| 101 | trace | 13939 | 0.002395648 | 0.476160 | kreadv |
| 101 | trace | 13939 | 0.002705664 | 0.310016 | kioctl |

Controlling the Trace Facility by Commands

If you configure the trace routine to run asynchronously (the -a option), you can control the trace facility with the following commands:

| | |
|---|---|
| trcon | Triggers collection of trace data on. |
| trcoff | Triggers collection of trace data off. |
| trcstop | Stops collection of trace data (like trcoff) and |
| | terminates the trace routine. |

Controlling the Trace Facility by Subroutines

The controls for the trace routine are available as subroutines from the librts.a library. The subroutines return zero on successful completion. The subroutines are:

| | |
|---|---|
| trcon | Triggers collection of trace data on. |
| trcoff | Triggers collection of trace data off. |
| trcstop | Stops collection of trace data (like trcoff) and |
| | terminates the trace routine. |

Controlling the trace Facility with ioctls Calls

The subroutines for controlling trace open the trace control device (/dev/systrctl), issue the appropriate ioctl command, close the control device and return. To control tracing around sections of code, it can be more efficient for a program to issue the ioctl controls directly. This avoids the unnecessary, repetitive opening and closing of the trace control device, at the expense of exposing some of the implementation details of trace control. To use the ioctl call in a program, include sys/trcctl.h to define the ioctl commands. The syntax of the ioctl is as follows:

ioctl (fd, CMA, Channel)

where:

| | |
|---|---|
| fd | File descriptor returned from opening |
| | /dev/systrctl |
| CMD | TRCON, TRCOFF, or TRCSTOP |
| Channel | Trace channel (0 for system trace). |

The following code sample shows how to start a trace from a program and only trace around a specified section of code:

```
#include <sys/trcctl.h>
extern int trcstart(char *arg);
char *ctl_dev =“/dev/systrctl”;
int ctl_fd
main( )
{
    printf(“configuring trace collection \n”);
    if (trcstart(“-ad”)){
    perror(“trcstart”);
        exit(1);
    }
    if((ctl_fd =open (ctl_dev))<0){
        perror(“open ctl_dev”);
        exit(1);
    }
    printf(“turning trace collection on \n”);
    if(ioctl(ctl_fd,TRCON,0)){
        perror(“TRCON”);
        exit(1);
    }
    /* code between here and trcoff ioctl will be
traced */
    printf(“turning trace off\n”);
    if (ioctl(ctl_fd,TRCOFF,0)){
        perror(“TRCOFF”);
        exit(1);
    }
    exit(0);
}
```

Producing a Trace Report

A trace report facility formats and displays the collected event stream in readable form. This report facility displays text and data for each event according to rules provided in the trace format file. The default trace format file is /etc/trcfmt and contains a stanza for each event ID. The stanza for the event provides the report facility with formatting rules for that event. This technique allows you to add your own events to programs and insert corresponding event stanzas in the format file to have their new events formatted.

This report facility does not attempt to extract summary statistics (such as CPU utilization and disk utilization) from the event stream. This can be done in several other ways. To create simple summaries, consider using awk scripts to process the output obtained from the trcrpt command.

### The trcrpt Command

The syntax of the trcrpt command is as follows:

trcrpt [-c ] [-d List] [-e Date] [-h] [-j ] [-k List] [-n Name] [-o File] [-p List] [-q] [-r ][ -s Date] [-t File] [-v] [-O Options] [-T List] [LogFile]

Normally the trcrpt output goes to standard output. However, it is generally more useful to redirect the report output to a file. The options are:

| -c | Causes the trcrpt command to check the syntax | |
|---|---|---|
| | of the trace format file. The trace format | |
| | file checked is either the default | |
| | (/etc/trcfmt) or the file specified by the -t | |
| | flag with this command. You can check the | |
| | syntax of the new or modified format files | |
| | with this option before attempting to use | |
| | them. | |
| -d List | Allows you to specify a list of events to be | |
| | included in the trcrpt output. This is useful | |
| | for eliminating information that is | |
| | superfluous to a given analysis and making the | |
| | volume of data in the report more manageable. | |
| | You may have commonly used event profiles, | |
| | which are lists of events that are useful for | |
| | a certain type of analysis. | |
| -e Date | Ends the report time with entries on, or | |
| | before the specified date. The Date parameter | |
| | has the form mmddhhmmssyy (month, day, hour, | |
| | minute, second, and year). Date and time are | |
| | recorded in the trace data only when trace | |
| | data collection is started and stopped. If you | |
| | stop and restart trace data collection | |
| | multiple times during a trace session, date | |
| | and time are recorded each time you start or | |
| | stop a trace data collection. Use this flag in | |
| | combination with the -s flag to limit the | |
| | trace data to data collected during a certain | |
| | time interval. | |
| -h | Omit the column headings of the report. | |
| -j | Causes the trcrpt command to produce a list of | |
| | all the defined events from the specified | |
| | trace format file. This option is useful in | |
| | creating an initial file that you can edit to | |
| | use as an include or exclude list for the | |
| | trcrpt or trace command. | |
| -k List | Similar to the -d flag, but allows you to | |
| | specify a list of events to exclude from the | |
| | trcrpt output. | |
| -n Name | Specifies the kernel name list file to be used | |
| | by trcrpt to convert kernel addresses to | |
| | routine names. If not specified, the report | |
| | facility uses the symbol table in /unix. A | |
| | kernel name list file that matches the system | |
| | the data was collected on is necessary to | |
| | produce an accurate trace report. You can | |
| | create such a file for a given level of system | |
| | with the trcnm command: | |
| | trcnm /unix > Name | |
| -o File | Writes the report to a file instead of to | |
| | standard output. | |
| -p List | Limits the trcrpt output to events that | |
| | occurred during the running of specific | |
| | processes. List the processes by process name | |
| | or process ID. | |
| -q | Suppresses detailed output of syntax error | |
| | messages. This is not an option you typically | |
| | use. | |
| -r | Produces a raw binary format of the trace | |
| | data. Each event is output as a record in the | |
| | order of occurrence. This is not necessarily | |
| | the order in which the events are in the trace | |
| | log file since the logfile can wrap. If you | |
| | use this option, direct the output to a file | |
| | (or process), since the binary form of the | |
| | data is not displayable. | |
| -t File | Allows you to specify a trace format file | |
| | other than the default (/etc/trcfmt). | |
| -T List | Limits the report to the kernel thread IDs | |
| | specified by the List parameter. The list | |
| | items are kernel thread IDs separated by | |
| | commas. Starting the list with a kernel thread | |
| | ID limits the report to all kernel thread IDs | |
| | in the list. Starting the list with a ! | |
| | (exclamation point) followed by a kernel | |
| | thread ID limits the report to all kernel | |
| | thread IDs not in the list. | |
| -O options | Allows you to specify formatting options to | |
| | the trcrpt command in a comma separated list. | |
| | Do not put spaces after the commas. These | |
| | options take the form of option=selection. If | |
| | you do not specify a selection, the command | |
| | uses the default selection. The possible | |
| | options are discussed in the following | |
| | sections. Each option is introduced by showing | |
| | its default selection. | |
| | 2line=off | This option lets the |
| | | user specify whether |
| | | the lines in the event |
| | | report are split and |
| | | displayed across two |
| | | lines. This is useful |
| | | when more columns of |
| | | information have been |
| | | requested than can be |
| | | displayed on the width |
| | | of the output device. |
| | cpuid=off | Lets you specify |
| | | whether to display a |
| | | column that contains |
| | | the physical processor |
| | | number. |
| | endtime=nnn.nnnnnnnnn | The starttime and |
| | | endtime option permit |
| | | you to specify an |
| | | elapsed time interval |
| | | in which the trcrpt |
| | | produces output. The |
| | | elapsed time interval |
| | | is specified in |
| | | seconds with |
| | | nanosecond resolution. |
| | exec=off | Lets you specify |
| | | whether a column |
| | | showing the path name |
| | | of the current process |
| | | is displayed. This is |
| | | useful in showing what |
| | | process (by name) was |
| | | active at the time of |
| | | the event. You |
| | | typically want to |
| | | specify this option. |
| | | We recommend that you |
| | | specify exec=on and |
| | | pid=on. |
| | ids=on | Lets you specify |
| | | whether to display a |
| | | column that contains |
| | | the event IDs. If the |
| | | selection is on, a |
| | | three-digit hex ID is |
| | | shown for each event. |
| | | The alternative is |
| | | off. |
| | pagesize=0 | Lets you specify how |
| | | often the column |
| | | headings is reprinted. |
| | | The default selection |
| | | of 0 displays the |
| | | column headings |
| | | initially only. A |
| | | selection of 10 |
| | | displays the column |
| | | heading every 10 |
| | | lines. |
| | pid=off | Lets you specify |
| | | whether a column |
| | | showing the process ID |
| | | of the current process |
| | | is displayed. It is |
| | | useful to have the |
| | | process ID displayed |
| | | to distinguish between |
| | | several processes with |
| | | the same executable |
| | | name. We recommend |
| | | that you specify |
| | | exec=on and pid=on. |
| | starttime=nnn.nnnnnnnnn | The starttime and |
| | | endtime option permit |
| | | you to specify an |
| | | elapsed time interval |
| | | in which the trcrpt |
| | | command produces |
| | | output. The elapsed |
| | | time interval is |
| | | specified in seconds |
| | | with nanosecond |
| | | resolution. |
| | svc=off | Lets you specify |
| | | whether the report |
| | | should contain a |
| | | column that indicates |
| | | the active system call |
| | | for those events that |
| | | occur while a system |
| | | call is active. |
| | tid=off | Lets you specify |
| | | whether a column |
| | | showing the thread ID |
| | | of the current thread |
| | | is displayed. It is |
| | | useful to have the |
| | | thread ID displayed to |
| | | distinguish between |
| | | several threads within |
| | | the same process. |
| | | Alternatively, you can |
| | | specify tid=on. |
| | timestamp=0 | The report can contain |
| | | two time columns. One |
| | | column is elapsed time |
| | | since the trace |
| | | command was initiated. |
| | | The other possible |
| | | time column is the |
| | | delta time between |
| | | adjacent events. The |
| | | option controls if and |
| | | how these times are |
| | | displayed. The |
| | | selections are: |
| | | 0 Provides both an |
| | | elapsed time from |
| | | the start of trace |
| | | and a delta time |
| | | between events. The |
| | | elapsed time is |
| | | shown in seconds and |
| | | the delta time is |
| | | shown in |
| | | milliseconds. Both |
| | | fields show |
| | | resolution to a |
| | | nanosecond. This is |
| | | the default value. |
| | | 1 Provides only an |
| | | elapsed time column |
| | | displayed as seconds |
| | | with resolution |
| | | shown to |
| | | microseconds. |
| | | 2 Provides both an |
| | | elapsed time and a |
| | | delta time column. |
| | | The elapsed time is |
| | | shown in seconds |
| | | with nanosecond |
| | | resolution, and |
| | | delta time is shown |
| | | in microseconds with |
| | | microsecond |
| | | resolution. |
| | | 3 Omits all time |
| | | stamps from the |
| | | report. |

| | |
|---|---|
| logfile | The logfile is the name of the file that |
| | contains the event data to be processed by the |
| | trcrpt command. The default is the |
| | /usr/adm/ras/trcfile file. |

Defining Trace Events

The operating system is shipped with predefined trace hooks (events). You need only activate trace to capture the flow of events from the operating system. You may want to define trace events in your code during development for tuning purposes. This provides insight into how the program is interacting with the system. The following sections provide the information that is required to do this.

Possible Forms of a Trace Event Record

A trace event can take several forms. An event consists of a
Hookword
Data words (optional)
A TID, or thread identifier
Timestamp (optional)

The “Format of a Trace Event Record” figure (below) illustrates a trace event. A four-bit type is defined for each form the event record can take. The type field is imposed by the recording routine so that the report facility can always skip from event to event when processing the data, even if the formatting rules in the trace format file are incorrect or missing for that event.

| | | |
|---|---|---|
| 12 bit | 14 bit | 16 bit |
| Hook ID | Type | Data Field |

D1 Optional Data Word 1
D2 Optional Data Word 2
D3 Optional Data Word 3
D4 Optional Data Word 4
D5 Optional Data Word 5
TID (Thread ID)
Optional Time Stamp

Format of a Trace Event Record

An event record should be as short as possible. Many system events use only the hookword and timestamp. There is another event type you should seldom use because it is less efficient. It is a long format that allows you to record a variable length of data. In this long form, the 16-bit data field of the hookword is converted to a length field that describes the length of the event record.

Macros for Recording Trace Events

There is a macro to record each possible type of event record. The macros are defined in the sys/tremacros.h header file. The event IDs are defined in the sys/trchkid.h header file. Include these two header files in any program that is recording trace events. The macros to record system (channel 0) events with a time stamp are:
TRCHKL0T (hw)
TRCHKL1T (hw,D1)
TRCHKL2T (hw,D1,D2)
TRCHKL3T (hw,D1,D2,D3)
TRCHKL4T (hw,D1,D2D3)
TRCHKL5T (hw,D1,D2,D3,D4,D5)

Similarly, to record non-time stamped system events (channel 0), use the following macros:
TRCHKL0 (hw)
TRCHKL1 (hw,D1)
TRCHKL2 (hw,D1,D2)
TRCHKL3 (hw,D1,D2,D3)
TRCHKL4 (hw,D1,D2,D3,D4)
TRCHKLS (hw,D1,D2,D3,D4,D5)

There are only two macros to record events to one of the generic channels (channels 1-7). These are:
TRCGEN (ch,hw,d1,len,buf)
TRCGENT (ch,hw,d1,len,buf)

These macros record a hookword (hw), a data word (d1) and a length of data (len) specified in bytes from the user's data segment at the location specified (buf) to the event stream specified by the channel (ch).

Use of Event IDS (hookids)

Event IDs are 12 bits (or 3-digit hexadecimal), for a possibility of 4096 IDS. Event IDS that are permanently left in and shipped with code need to be permanently assigned. Permanently assigned event IDs are defined in the sys/trchkid.h header file.

To allow you to define events in your environments or during development, a range of event IDs exist for temporary use. The range of event IDs for temporary use is hex 010 through hex OFF. No permanent (shipped) events are assigned in this range. You can freely use this range of IDs in your own environment. If you do use IDs in this range, do not let the code leave your environment.

Permanent events must have event IDs assigned by the current owner of the trace component. You should conserve event IDs because they are limited. Event IDs can be extended by the data field. The only reason to have a unique ID is that an ID is the level at which collection and report filtering is available in the trace facility. An ID can be collected or not collected by the trace collection process and reported or not reported by the trace report facility. Whole applications can be instrumented using only one event ID. The only restriction is that the granularity on choosing visibility is to choose whether events for that application are visible.

A new event can be formatted by the trace report facility (trcrpt command) if you create a stanza for the event in the trace format file. The trace format file is an editable ASCII file. The syntax for a format stanzas is shown below in “Syntax for Stanzas in the trace Format File”. All permanently assigned event IDs should have an appropriate stanza in the default trace format file shipped with the base operating system.

Suggested Locations and Data for Permanent Events

The intent of permanent events is to give an adequate level of visibility to determine execution, and data flow, and have an adequate accounting for how CPU time is being consumed. During code development, it can be desirable to make very detailed use of trace for a component. For example, you can choose to trace the entry and exit of every subroutine in order to understand and tune pathlength. However, this would generally be an excessive level of instrumentation to ship for a component.

We suggest that you consult a performance analyst for decisions regarding what events and data to capture as permanent events for a new component. The following paragraphs provide some guidelines for these decisions.

Events should capture execution flow and data flow between major components or major sections of a component. For example, there are existing events that capture the interface between the virtual memory manager and the logical volume manager. If work is being queued, data that identifies the queued item (a handle) should be recorded with the event. When a queue element is being processed, the “dequeue” event should provide this identifier as data also, so that the queue element being serviced is identified.

Data or requests that are identified by different handles at different levels of the system should have events and data that allow them to be uniquely identified at any level. For example, a read request to the physical file system is identified by a file descriptor and a current offset in the file. To a virtual memory manager, the same request is identified by a segment ID and a virtual page address. At the disk device driver level, this request is identified as a pointer to a structure which contains pertinent data for the request.

The file descriptor or segment information is not available at the device driver level. Events must provide the necessary data to link these identifiers so that, for example, when a disk interrupt occurs for incoming data, the identifier at that level (which can simply be the buffer address for where the data is to be copied) can be linked to the original user request for data at some offset into a file.

Events should provide visibility to major protocol events such as requests, responses, acknowledgements, errors, and retries. If a request at some level is fragmented into multiple requests, a trace event should indicate this and supply linkage data to allow the multiple requests to be tracked from that point. If multiple requests at some level are coalesced into a single request, a trace event should also indicate this and provide appropriate data to track the new request.

Use events to give visibility to resource consumption. Whenever resources are claimed, returned, created or deleted an event should record the fact. For example, claiming or returning buffers to a buffer pool or growing or shrinking the number of buffers in the pool.

The following guidelines can help you determine where and when you should have trace hooks in your code:
Tracing entry and exit points of every function is not necessary. Provide only key actions and data.
Show linkage between major code blocks or processes.
If work is queued, associate a name (handle) with it and output it as data.
If a queue is being serviced, the trace event should indicate the unique element being serviced.
If a work request or response is being referenced by different handles as it passes through different software components, trace the transactions so the action or receipt can be identified.
Place trace hooks so that requests, responses, errors, and retries can be observed.
Identify when resources are claimed, returned, created, or destroyed.

Also note that:
A trace ID can be used for a group of events by “switching” on one of the data fields. This means that a particular data field can be used to identify from where the trace point was called. The trace format routine can be made to format the trace data for that unique trace point.
The trace hook is the level at which a group of events can be enabled or disabled. Note that trace hooks can be grouped in SMIT. For more information, see “SMIT Trace Hook Groups”.

Syntax for Stanzas in the Trace Format File

The intent of the trace format file is to provide rules for presentation and display of the expected data for each event ID. This allows new events to be formatted without changing the report facility. Rules for new events are simply added to the format file. The syntax of the rules provides flexibility in the presentation of the data.

A trace format stanza can be as long as required to describe the rules for any particular event. The stanza can be continued to the next line by terminating the present line with a \ (backslash) character. The fields are:

| | |
|---|---|
| event_id | Each stanza begins with the three-digit |
| | hexadecimal event ID that the stanza |
| | describes, followed by a space. |
| V.R | This field describes the version (V) and |
| | release (R) that the event was first |
| | assigned. Any integers work for V and R, |
| | and you may want to keep your own |
| | tracking mechanism. |
| L = | The text description of an event can |
| | begin at various indentation levels. This |
| | improves the readability of the report |
| | output. The indentation levels correspond |
| | to the level at which the system is |
| | running. The recognized levels are: |
| | APPL Application level |
| | SVC Transitioning system call |
| | KERN Kernel level |
| | INT Interrupt |
| event_label | The event_label is an ASCII text string |
| | that describes the overall use of the |
| | event ID. This is used by the −j option |
| | of the trcrpt command to provide a |
| | listing of events and their first level |
| | description. The event label also appears |
| | in the formatted output for the event |
| | unless the event_label field starts with |
| | an @ character. |
| \n | The event stanza describes how to parse, |
| | label and present the data contained in |
| | an event record. You can insert a \n |
| | (newline) in the event stanza to continue |
| | data presentation of the data on a new |
| | line. This allows the presentation of the |
| | data for an event to be several lines |
| | long. |
| \t | The \t (tab) function inserts a tab at |
| | the point it is encountered in parsing |
| | the description. This is similar to the |
| | way the \n function inserts new lines. |
| | Spacing can also be inserted by spaces in |
| | the data_label or match_label fields. |
| starttimer(#,#) | The starttimer and endtimer fields work |
| | together. The (#, #) field is a unique |
| | identifier that associates a particular |
| | starttimer value with an endtimer that |
| | has the same identifier. By convention, |
| | if possible, the identifiers should be |
| | the ID of starting event and the ID of |
| | the ending event. |
| | When the report facility encounters a |
| | start timer directive while parsing an |
| | event, it associates the starting events |
| | time with the unique identifier. When an |
| | end timer with the same identifier is |
| | encountered, the report facility outputs |
| | the delta time (this appears in brackets) |
| | that elapsed between the starting event |
| | and ending event. The begin and end |
| | system call events make use of this |
| | capability. On the return from system |
| | call event, a delta time is shown that |
| | indicates how long the system call took. |
| endtimer(#, #) | See the starttimer field in the preceding |
| | paragraph. |
| data_descriptor | The data_descriptor field is the |
| | fundamental field that describes how the |
| | report facility consumes, labels, and |
| | presents the data. The “Syntax of the |
| | data_descriptor Field” figure (below) |
| | illustrates this field's syntax. |
| | The various subfields of the |
| | data_descriptor field are: |
| | data_label The data label is an ASCII |
| | string that can optionally precede the |
| | output of data consumed by the following |
| | format field. |
| | format Review the format of an event |
| | record depicted in the figure “Format of |
| | a trace Event Record”. You can think of |
| | the report facility as having a pointer |
| | into the data portion of an event. This |
| | data pointer is initialized to point to |
| | the beginning of the event data (the 16- |
| | bit data field in the hookword). The |
| | format field describes how much data the |
| | report facility consumes from this point |
| | and how the data is considered. For |
| | example, a value of Bm.n tells the report |
| | facility to consume m bytes and n bits of |
| | data and to consider it as binary data. |
| | The possible format fields are described |
| | in the following section. If this field |
| | is not followed by a comma, the report |
| | facility outputs the consumed data in the |
| | format specified. If this field is |
| | followed by a comma, it signifies that |
| | the data is not to be displayed but |
| | instead compared against the following |
| | match_vals field. The data descriptor |
| | associated with the matching match_val |
| | field is then applied to the remainder of |
| | the data. |
| | match_val The match value is data of the |
| | same format described by the preceding |
| | format fields. Several match values |
| | typically follow a format field that is |
| | being matched. The successive match |
| | fields are separated by commas. The last |
| | match value is not followed by a coma. |
| | Use the character string \* as a pattern |
| | matching character to match anything. A |
| | pattern-matching character is frequently |
| | used as the last element of the match_val |
| | field to specify default rules it the |
| | preceding match_val field did not occur. |
| | match_label The match label is an ASCII |
| | string that is output for the |
| | corresponding match. |

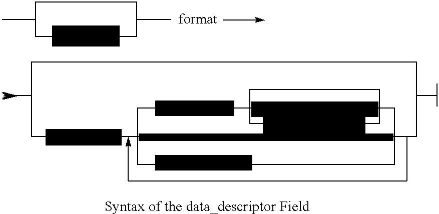

Each of the possible format fields is described in the comments of the /etc/trcfmt file. The following shows several possibilities:

| Format field | descriptions |
|---|---|
| Am.n | This value specifies that m bytes of data |
| | are consumed as ASCII text, and that it is |
| | displayed in an output field that is n |
| | characters wide. The data pointer is moved m |
| | bytes. |
| S1, S2, S4 | Left justified string. The length of the |
| | field is defined as 1 byte (S1), 2 bytes |
| | (S2), or 4 bytes (S4). The data pointer is |
| | moved accordingly. |
| Bm.n | Binary data of m bytes and n bits. The data |
| | pointer is moved accordingly. |
| Xm | Hexadecimal data of m bytes. The data |
| | pointer is moved accordingly. |
| D2, D4 | Signed decimal format. Data length of 2 (D2) |
| | bytes or 4 (D4) bytes is consumed. |
| U2, U4 | Unsigned decimal format. Data length of 2 or |
| | 4 bytes is consumed. |
| F4, F8 | Floating point of 4 or 8 bytes. |
| Gm.n | Positions the data pointer. It specifies |
| | that the data pointer is positioned m bytes |
| | and n bits into the data. |
| Om.n | Skip or omit data. It omits m bytes and n |
| | bits. |
| Rm | Reverse the data pointer to bytes. |

Some macros are provided that can be used as format fields to quickly access data. For example:

| | |
|---|---|
| $D1, $D2, $D3, $D4, $D5 | These macros access data words 1 |
| | through 5 of the event record |
| | without moving the data pointer. |
| | The data accessed by a macro is |
| | hexadecimal by default. A macro |
| | can be cast to a different data |
| | type (X, D, U, B) by using a % |
| | character followed by the new |
| | format code. For example, the |
| | following macro causes data word |
| | one to be accessed, but to be |
| | considered as 2 bytes and 3 bits |
| | of binary data: |
| | $D1%B2.3 |
| $HD | This macro accesses the first 16 |
| | bits of data contained in the |
| | hookword, in a similar manner as |
| | the $D1 through $D5 macros access |
| | the various data words. It is |
| | also considered as hexadecimal |
| | data, and also can be cast. |

You can define other macros and use other formatting techniques in the trace format file. This is shown in the following trace format file example.

Example Trace Format File

# .
# .
# .
#
# I. General Information
#
# A. Binary format for the tracehook calls. (1 column = 4 bits)
# trchk MMmTDDDD
# trchkt MMmTDDDDtttttttt
# trchkl MMmTDDDD11111111
# trchklt MMmTDDDD11111111tttttttt
# trchkg MMmTDDDD1111111122222222333333334444444455555555
# trchkg MMmTDDDD1111111122222222333333334444444455555555tttttttt
# trcgen MMmTLLLL11111111vvvvvvvvvvvvvvvvvvvvvvvvvvxxxxxx
# trcgent MMmTLLLL11111111vvvvvvvvvvvvvvvvvvvvvvvvvvxxxxxxtttttttt
#
# legend:
# MM = major id
# m = minor id
# T = hooktype
# D = hookdata
# t = nanosecond timestamp
# 1 = d1 (see trchkid.h for calling syntax for the tracehook routines)
# 2 = d2, etc.
# v = trcgen variable length buffer
# L = length of variable length data in bytes.
#
# The DATA_POINTER starts at the third byte in the event, ie.,
# at the 16 bit hookdata DDDD.
# The trcgen( ) type (6,7) is an exception.The DATA_POINTER starts at
# the fifth byte, ie., at the ′d1′ parameter 11111111.
#
# B. Indentation levels
# the left margin is set per template using the ′L=XXXX′ command.
# The default is L=KERN, the second column.
# L=APPL moves the left margin to the first column.
# L=SVC moves the left margin to the second column.
# L=KERN moves the left margin to the third column.
# L=INT moves the left margin to the fourth column.
# The command if used must go just after the version code.
#
# Example usage:
#113 1.7 L=INT ″stray interrupt″ ... \
#
# C. Continuation code and delimiters.
# A ′\′ at the end of the line must be used to continue the template
# on the next line.
# Individual strings (labels) can be separated by one or more blanks
# or tabs. However, all whitespace is squeezed down to 1 blank on
# the report. Use ′\t′ for skipping to the next tabstop, or use
# A0.X format (see below) for variable space.
#
#
# II. FORMAT codes
#
# A. Codes that manipulate the DATA_PONTER
# Gm.n
# ″Goto″ Set DATA_POINTER to byte.bit location m.n
#
# Om.n
# ″Omit″ Advance DATA_POINTER by m.n byte.bits
#
# Rm
# ″Reverse″ Decrement DATA_POINTER by m bytes. R0 byte aligns.
#
# B. Codes that cause data to be output.
# Am.n
# Left justified ascii.
# m=length in bytes of the binary data.
# n=width of the displayed field.
# The data pointer is rounded up to the next byte boundary.
# Example
# DATA_POINTER|
# V
# xxxxxhello world\0xxxxxx
#
# i. A8.16 results in: |hello wo |
# DATA_POINTER--------|
# V
# xxxxxhello world\0xxxxxx
#
# ii. A16.16 results in: |hello world |
# DATA_POINTER----------------|
# V
# xxxxxhello world\0xxxxxx
#
# iii. A16 results in: |hello world|
# DATA_POINTER----------------|
# V
# xxxxxhello world\0xxxxxx
#
# iv. A0.16 results in: | |
# DATA_POINTER|
# V
# xxxxxhello world\0xxxxxx
#
# S1, S2, S4
# Left justified ascii string.
# The length of the string is in the first byte(half-word, word)
# of the data. This length of the string does not include this byte.
# The data pointer is advanced by the length value.
# Example
# DATA_POINTER|
# V
# xxxxxBhello worldxxxxxx (B = hex 0x0b)
#
# i. S1 results in: |hello world|
# DATA_POINTER|
# V
# xxxxxBhello worldxxxxxx
#
# $reg%S1
# A register with the format code of ′Sx′ works ″backwards″
# from a register with a different type. The format is Sx,
# but the length of the string comes from $reg instead of the
# next n bytes.
#
# Bm.n
# Binary format.
# m = length in bytes
# n = length in bits
# The length in bits of the data is m * 8 + n. B2.3 and B0.19
# are the same. Unlike the other printing FORMAT codes, the
# DATA_POINTER can be hit aligned and is not rounded up to
# the next byte boundary.
#
# Xm
# Hex format.
# m = length in bytes. m=0 thru 16
# The DATA_POINTER is advanced by m.
#
# D2, D4
# Signed decimal format.
# The length of the data is 2 (4) bytes.
# The DATA_POINTER is advanced by 2 (4).
#
# U2, U4
# Unsigned decimal format.
# The length of the data is 2 (4) bytes.
# The DATA_POINTER is advanced by 2 (4).
#
# F4
# Floating point format. (like %0.4E)
# The length of the data is 4 bytes.
# The format of the data is that of C type ′float′.
# The DATA_POINTER is advanced by 4.
#
# F8
# Floating point format. (like %0.4E)
# The length of the data is 8 bytes.
# The format of the data is that of C type ′double′.
# The DATA_POINTER is advanced by 8.
#
#
#
# HB
# Number of bytes in trcgen( ) variable length buffer.
# This is also equal to the 16 bit hookdata.
# The DATA_POINTER is not changed.
#
# HT
# The hooktype. (0 - E)
# trcgen = 0, trchk = 1, trchl = 2, trchkg = 6
# trcgent = 8, trchkt = 9, trchlt = A, trchkgt = E
# HT & 0x07 masks off the timestamp bit
# This is used for allowing multiple, different trchkx( ) calls with
# the same template.
# The DATA_POINTER is not changed.
#
# C. Codes that interpret the data in some way before output.
# T4
# Output the next 4 bytes as a data and time string,
# in GMT timezone format. (as in ctime(&seconds))
# The DATA_POINTER is advanced by 4.
#
# E1,E2,E4
# Output the next byte (half_word, word) as an ′errno′ value,
# replacing the numeric code with the corresponding #define name in
# /usr/include/sys/errno.h
# The DATA_POINTER is advanced by 1, 2, or 4.
#
# P4
# Use the next word as a process id (pid), and output the
# pathname of the executable with that process id.Process
# ids and their pathnames are acquired by the trace command at
# the start of a trace and by trcrpt via a special EXEC tracehook.
# The DATA_POINTER is advanced by 4.
#
# \t
# Output a tab. \t\t\t outputs 3 tabs. Tabs are expanded to spaces,
# using a fixed tabstop separation of 8.If L=0 indentation is used,
# the first tabstop is at 3.
# The DATA_POINTER advances over the \t.
#
# \n
# Output a newline. \n\n\n outputs 3 newlines.
# The newline is left-justified eccording to the INDENTATION LEVEL.
# The DATA_POINTER advances over the \n.
#
# $macro
# The value of ′macro′ is output as a %04X value. Undefined
# macros have the value of 0000.
# The DATA_POINTER is not changed.
# An optional format can be used with macros:
# $v1%X4 will output the value $v1 in X4 format.
# $zz%B0.8 will output the value $v1 in 8 bits of binary.
# Understood forts are: X, D, U, B. Others default to X2.
#
# ″string″ ′string′ data type
# Output the characters inside the double quotes exactly. A string
# is treated as a descriptor. Use ″ ″ as a NULL string.
#
#
#
# ′string format $macro′ If a string is backquoted, it is expanded
# as a quoted string, except that FORMAT codes and $registers are
# expanded as registers.
#
# III. SWITCH statement
# A format code followed by a comma is a SWITCH statement.
# Each CASE entry of the SWITCH statement consists of
# 1. a ′matchvalue′ with a type (usually numeric) corresponding
# to the format code.
# 2. a simple ′string′ or a new ′descriptor′ bounded by braces.
# A descriptor is a sequence of format codes, strings,
# switches and loops.
# 3. and a comma delimiter.
# The switch is terminated by a CASE entry without a comma
# delimiter. The CASE entry is selected to as the first
# entry whose matchvalue is equal to the expansion of the format
# code. The special matchvalue ′\*′ is a wildcard and matches
# anything.
# The DATA_POINTER is advanced by the format code.
#
#
# IV. LOOP statement
# The syntax of a ′loop′ is
# LOOP format_code { descriptor }
# The descriptor is executed N times, where N is the numeric value
# of the format code.The DATA_POINTER is advanced by the
# format code plus whatever the descriptor does. Loops are used to
# output binary buffers of data, so descriptor is
# usually simply X1 or X0. Note that X0 is like X1 but does not
# supply a space separator ′ ′ between each byte.
#
# V. macro assignment and expressions
# ′macros′ are temporary (for the duration of that event) variables
# that work like shell variables.
# They are assigned a value with the syntax:
# {{ $xxx = EXPR }}
# where EXPR is a combination of format codes, macros, and constants.
# Allowed operators are + − / *
# For example:
#{{ $dog = 7 + 6 }} {{ $cat = $dog * 2 }} $dog $cat
#
# will output:
#000D 001A
#
# Macros are useful in loops where the loop count is not always
# just before the data:
#G1.5 {{ $count = B0.5 }} G11 LOOP $count (X0)
#
# Up to 25 macros can be defined per template.
#
#
# VI. Special macros:
# $RELLINENO line number for this event. The first line starts at 1.
# $D1 – $D5 dataword 1 through dataword 5. No change to datapointer.
# $HD hookdata (lower 16 bits)
# $SVC Output the name of the current EVO
# $EXECPATH Output the pathname of the executable for current process.
# $PID Output the current process id.
# $ERROR Output an error message to the report and exit from the
# template after the current descriptor is processed.
# The error message supplies the logfile, logfile offset of
# the start of that event, and the traceid.
# $LOGIDX Current logfile offset into this event.
# $LOGIDX0 Like $LOGIDX, but is the start of the event.
# $LOGFILE Name of the logfile being processed.
# $TRACEID Traceid of this event.
# $DEFAULT Use the DEFAULT template 008
# $STOP End the trace report right away
# $BREAK End the current trace event
# $SKIP Like break, but don't print anything out.
# $DATAPOINTER The DATA_POINTER. It can be set and manipulated
# like other user-macros.
# {{ $DATAPOINTER = 5 }} is equivalent to G5
# $BASEPOINTER Usually 0. It is the starting offset into an event.The
# actual offset is the DATA_POINTER + BASE_POINTER. It is used
# with template subroutines, where the parts on an event have
# the same structure, and can be printed by the same template,
# but may have different starting points into an event.
#
# VII. Template subroutines
# If a macro name consists of 3 hex digits, it is a ″template
# subroutine″. The template whose traceid equals the macro name
# is inserted in place of the macro.
#
# The data pointer is where is was when the template
# substitution was encountered.Any change made to the data pointer
# by the template subroutine remains in affect when the template
# ends.
#
# Macros used within the template subroutine correspond to those
# in the calling template. The first definition of a macro in the
# called template is the same variable as the first in the called.
# The names are not related.
#
# Example:
# Output the trace label ESDI STRATEGY.
# The macro ′$stat′ is set to bytes 2 and 3 of the trace event.
# Then call template 90F to interpret a buf header. The macro
# ′$return′ corresponds to the macro ′$rv′, since they were
# declared in the sane order. A macro definition with
# no ′=′ assignment just declares the name
# like a place holder. When the template returns,the saved special
# status word is output and the returned minor device number.
#900 1.0 ″ESDI STRATEGY″ {{ $rv = 0 }} {{ $stat = X2 }} \
# $90F \n\
#special_esdi_status=$stat for minor device $rv
#
#90F 1.0 ″ ″ G4 {{ $return }} \
# block number X4 \n\
# byte count X4 \n\
# B0.1, 1 B_FLAG0 \
# B0.1, 1 B_FLAG1 \
# B0.1, 1 B_FLAG2 \
# G16 {{ $return = X2 }}
#
# Note: The $DEFAULT reserved macro is the same as $008
#
#
# VII. BITFLAGS statement
# The syntax of a ′bitflags′ is
# BITFLAGS [format_code|register],
# flag_value string {optional string if false}, or
# ′&′ mask field_value string,
#
# ...
#
# This statemen: simplifies expanding state flags, since it look
# a lot like a series of #defines.
# The ′&′ mask is used for interpreting bit fields.
# The mask is anded to the register and the result is compared to
# the field_value. If a match, the string is printed.
# The base is 16 for flag_values and masks.
# The DATA_POINTER is advanced if a format code is used.
# Note:the default base for BITFLAGS is 16. If the mask or field
# value has a leading 0, the number is octal. 0x or 0X makes the
# number hex.
# A 000 traceid will use this template
# This id is also used to define most of the template functions.
# filemode(omode} expand omode the way ls −l does. The
# call to setdelim( ) inhibits spaces between the chars.
#

Examples of Coding Events and Formatting Events

There are five basic steps involved in generating a trace from your software program.

Step 1: Enable the Trace

Enable and disable the trace from your software that has the trace hooks defined. The following code shows the use of trace events to time the running of a program loop.

```
#include <sys/trcctl.h>
#include <sys/trcmacros.h>
#include <sys/trchkid.h>
char *ctl_file = “/dev/systrctl”;
int ctlfd;
int i;
main( )
{
    printf(“configuring trace collection \n”);
    if (trcstart(“−ad”)){
        perror(“trcstart”);
        exit(1);
    }
    if((ctlfd = open(ctl_file,0))<0){
        perror(ctl_file);
        exit(1);
    }
    printf(“turning trace on \n”);
    if(ioctl(ctlfd,TRCON,0)){
        perror(“TRCON”);
        exit(1);
    }
    /* here is the code that is being traced */
    for(i=1;i<11;i++){
        TRCHKL1T(HKWD_USER1,i);
        /* sleep(1) */
/* you can uncomment sleep to make the loop
/*
take longer. If you do, you will want to
        /* filter the output or you will be */
        /* overwhelmed with 11 seconds of data */
    }
    /* stop tracing code */
    printf(“turning trace off\n”);
    if(ioctl(ctlfd,TRCSTOP,0)){
        perror(“TRCOFF”);
        exit(1);
    }
    exit(0);
}
```

Step 2: Compile Your Program

When you compile the sample program, you need to link to the librts.a library:

cc -o sample sample.c -l rts

Step 3: Run the Program

Run the program. In this case, it can be done with the following command:

./sample

You must have root privilege if you use the default file to collect the trace information (/usr/adm/ras/trcfile).

Step 4: Add a Stanza to the Format File

This provides the report generator with the information to correctly format your file. The report facility does not know how to format the HKWD_USER1 event, unless you provide rules in the trace format file.

The following is an example of a stanza for the HKWD_USER1 event. The HKWD_USER1 event is event ID 010 hexadecimal. You can verify this by looking at the sys/trchkid.h header file.

| # User event HKWD_USER1 Formatting Rules Stanza | |
|---|---|
| # An example that will format the event usage of the sample | |
| program | |
| 010 1.0 L=APPL | “USER EVENT - HKWD_USER1” O2.0 \n\ |
| | “The # of loop iterations =” U4\n\ |
| | “The elapsed time of the last loop = ”\ |
| | endtimer(0x010,0x010) starttimer(0x010, |
| 0x010) | |

Note: When entering the example stanza, do not modify the master format file /etc/trcfmtt Instead, make a copy and keep it in your own directory. This allows you to always have the original trace format file available.

Step 5: Run the Format/Filter Program

Filter the output report to get only your events. To do this, run the trcrpt command:

trcrpt -d 010 -t mytrcfmt -O exec=on -o sample.rpt

The formatted trace results are:

ID ROC NAME I ELAPSED_SEC DELTA_MSEC APPL SYSCALL KERNEL INTERRUPT 010 sample 0.000105984 0.105984 USER HOOK 1

The data field for the user hook=1 010 sample 0.000113920 0.007936 USER HOOK 1

The data field for the user hook=2 [7 usec] 010 sample 0.000119296 0.005376 USER HOOK 1

The data field for the user hook=3 [5 usec] 010 sample 0.000124672 0.005376 USER HOOK 1

the data field for the user hook=4 [5 usec] 010 sample 0.000129792 0.005120 USER HOOK 1

The data field for the user hook=5 [5 usec] 010 sample 0.000135168 0.005376 USER HOOK 1

the data field for the user hook=6 [5 usec] 010 sample 0.000140288 0.005120 USER HOOK 1

the data field for the user hook=7 [5 usec] 010 sample 0.000145408 0.005120 USER HOOK 1

The data field for the user hook=8 [5 usec] 010 sample 0.000151040 0.005632 USER HOOK 1

The data field for the user hook=9 [5 usec] 010 sample 0.000156160 0.005120 USER HOOK 1

The data field for the user hook=10[5 usec]

Usage Hints

The following sections provide some examples and suggestions for use of the trace facility.

Viewing Trace Data

Include several optional columns of data in the trace output. This causes the output to exceed 80 columns. It is best to view the reports on an output device that supports 132 columns.

Bracketing Data Collection

Trace data accumulates rapidly. Bracket the data collection as closely around the area of interest as possible. One technique for doing this is to issue several commands on the same command line. For example, the command:

trace -a; cp /etc/trcfmt /tmp/junk; trcstop

captures the total execution of the copy command.

Note: This example is more educational if the source file is not already cached in system memory. The trcfmt file can be in memory if you have been modifying it or producing trace reports. In that case, choose as the source file some other file that is 50 to 100 KB and has not been touched.

Reading a Trace Report

The trace facility displays system activity. It is a useful learning tool to observe how the system actually performs. The previous output is an interesting example to browse. To produce a report of the copy, use the following:

trcrpt -O “exec=on,pid=on”>cp.rpt

In the cp.rpt file you can see the following activities:
The fork, exec, and page fault activities of the cp process.
The opening of the /etc/trcfmt file for reading and the creation of the /tmp/junk file.
The successive read and write subroutiness to accomplish the copy.
The cp process becoming blocked while waiting for I/O completion, and the wait process being dispatched.
How logical volume requests are translated to physical volume requests.
The files are mapped rather than buffered in traditional kernel buffers. The read accesses cause page faults that must be resolved by the virtual memory manager.
The virtual memory manager senses sequential access and begins to prefetch the file pages.
The size of the prefetch becomes larger as sequential access continues.
The writes are delayed until the file is closed (unless you captured execution of the sync daemon that periodically forces out modified pages).
The disk device driver coalesces multiple file requests into one I/O request to the drive when possible.

The trace output looks a little overwhelming at first. This is a good example to use as a learning aid. If you can discern the activities described, you are well on your way to being able to use the trace facility to diagnose system performance problems.

Effective Filtering of the Trace Report

The full detail of the trace data may not be required. You can choose specific events of interest to be shown. For example, it is sometimes useful to find the number of times a certain event occurred. Answer the question, “how many opens occurred in the copy example?” First, find the event ID for the open subroutine:

trcrpt -j|pg

You can see that event AD 15b is the open event. Now, process the data from the copy example (the data is probably still in the log file) as follows:

trcrpt -d 15b -O “exercon”

The report is written to standard output and you can determine the number of opens that occurred. If you want to see only the opens that were performed by the cp process, run the report command again using:

trcrpt -d 15b -p cp -O “exec=on”

This command shows only the opens performed by the cp process.

SMIT Trace Hook Groups

Combining multiple trace hooks into a trace hook group allows all hooks to be turned on at once when starting a trace

The first item on the Start Trace menu is EVENT GROUPS to trace. The groups that can be traced are defined in the SWservAt ODM object class. Each group uses the Name_trcgrpdesc and Name_trcgrp attributes. Name is the name of the trace group that must be no longer than 8 characters. The _trcgrpdesc attribute specifies the group description, and the _trcgrp attribute specifies the trace hooks in the group. A group can have only one _trcgrpdesc descriptionr but it can have multiple _trcgrp hook lists.

The following example shows the definition of the general kernel activity (gka) trace group.

SWservAt:
attribute=“gka_trcgrpdesc”
value=“GENERAL KERNEL ACTIVITY (files, execs, dispatches)”

SWservAt:
attribute=“gka_trcgrp”
value=“106, 134, 139, 107, 135, 15b, 12e”

Note that the value of gka_trcgrpdesc is shown by SMIT as the description of the group. The value list for gka_trcgrp contains the hooks in the group. You can add another gka_trcgrp attribute to add additional trace hooks to that group. The hook ids must be enclosed in double quotes (″) and separated by commas.

What is claimed is:

1. A method for selectively enabling trace points associated with events in a data processing system, comprising steps of:
using an ordered list of events, which lists events that have previously occurred within the data processing system, to selectively enable and disable trace points associated with the events based upon resource consumption of the data processing system.

2. The method of claim 1, wherein the ordered list of events is a log of event identifiers for events occurring in the data processing system.

3. The method of claim 1, wherein a last to occur event in the ordered list of events is a first event to have at least one of its trace points enabled when the resource consumption of the data processing system is below a predetermined threshold.

4. The method of claim 3, wherein the resource consumption is one of CPU consumption and trace buffer consumption.

5. The method of claim 1, further comprising steps of:
logging event identifiers for events occurring in the data processing system to generate the ordered list, the event identifiers being logged without associated detailed event description information for the events; and
upon detection of an error in the data processing system, logging both (i) the event identifiers and (ii) detailed event description information for events occurring in the data processing system subsequent to the error detection, wherein at least one trace point associated with a given one of the subsystems is dynamically enabled and disabled based upon resource consumption of the data processing system.

6. The method of claim 5, wherein a last to occur event in the ordered list of events is a first event to have at least one of its trace points enabled when the resource consumption of the data processing system is below a predetermined threshold.

7. A computer program product comprising a computer usable medium having computer usable program code for tracing operations in a data processing system, the computer program product including:
computer usable program code for changing, upon occurrence of an error condition when the data processing system is in a first state, from the first state to a second state, wherein while in the first state the data processing system traces a plurality of enabled trace points within at least one subsystem of the plurality of subsystems; and
computer usable program code for determining, while in the second state, if any system consumption rates exceed a threshold and if so, selectively disabling certain enabled trace points until the system consumption rates are not exceeded.

8. The computer program product of claim 7, further comprising computer usable program code for enabling, if the system consumption rate does not exceed the threshold, additional trace points to be traced from another of the plurality of subsystems and then again determining if any of the system consumption rates exceeds the threshold, and (i) if so, selectively disabling certain enabled trace points until the system consumption rates are not exceeded, (ii) if not, enabling further additional trace points to be traced from an additional one of the plurality of subsystems.

9. The computer program product of claim 8, wherein the data processing system generates a log of event identifiers for events occurring in the data processing system when tracing the plurality of enabled trace points, and wherein a last to occur event in the log of event identifiers is a first event to have at least one of its trace points enabled when the resource consumption of the data processing system is below a predetermined threshold.

10. The computer program product of claim 7, wherein the error condition is received from an error event handler.

11. The computer program product of claim 7, wherein the system consumption rate is based on one of CPU consumption and trace buffer consumption.

12. A system for tracing operations on a data processing system having a plurality of subsystems, comprising:
means for changing, upon occurrence of an error condition when the data processing system is in a normal state, from the normal state to an error state, wherein while in the error state the data processing system traces execution of each of the plurality of subsystems;
means for changing, upon occurrence of another error condition when the data processing system is in the error state, from the error state to a dynamic tracing state, wherein while in the dynamic tracing state the data processing system traces a plurality of enabled trace points within at least one subsystem of the plurality of subsystems; and
means for determining, while in the dynamic tracing state, if at least one system consumption rate exceeds a threshold and if so, selectively disabling certain enabled trace points until the at least one system consumption rate is not exceeded.

13. The system of claim 12, further comprising means for enabling, if the at least one system consumption rate does not exceed the threshold, additional trace points to be traced from another of the plurality of subsystems and then again determining if at least one system consumption rate exceeds the threshold, and (i) if so, selectively disabling certain enabled trace points until the at least one system consumption rate is not exceeded, (ii) if not, enabling further additional trace points to be traced from an additional one of the plurality of subsystems.

14. The system of claim 13, wherein the data processing system generates a log of event identifiers for events occurring in the data processing system when tracing the execution of each of the plurality of subsystems, and wherein a last to occur event in the log of event identifiers is a first event to have at least one of its trace points enabled when the resource consumption of the data processing system is below a predetermined threshold.

15. The system of claim 12, wherein the error condition is received from an error event handler.

16. The system of claim 12, wherein the at least one system consumption rate is based on at least one of CPU consumption and trace buffer consumption.
